(19) United States
(12) Patent Application Publication
(10) Pub. No.: US 2024/0165863 A1
(43) Pub. Date: May 23, 2024

(54) APPARATUS FOR FIXING INSERT MEMBER IN MOLD, MOLD APPARATUS, AND INSERT MOLDING METHOD

(71) Applicant: KONEC Co., Ltd., Seosan-si (KR)

(72) Inventors: Hyun Soo SHIN, Siheung-si (KR); Kwang-Pyo Lee, Seongnam-si (KR)

(21) Appl. No.: 18/380,417

(22) Filed: Oct. 16, 2023

(30) Foreign Application Priority Data
Nov. 22, 2022 (KR) 10-2022-0157516

(51) Int. Cl. B29C 45/14; B29C 45/26

(52) U.S. Cl. CPC B29C 45/14065; B29C 45/26; B29C 2045/14122; B29C 2045/14131

(57) ABSTRACT

An apparatus for fixing an insert member in a mold includes a groove formed on the inner circumferential surface of the insert member, a coupling protrusion protruding from the mold so that the insert member is inserted over the coupling protrusion, at least one hook member coupled to the mold such that a hook member moves between a protrusion position and a retreat position, and a driving unit for moving the at least one hook member between the protrusion position and the retreat position, wherein when the hook member is located at the protrusion position, the one end of the hook member engages with the groove of the insert member, and when the hook member is located at the retreat position, the one end of the hook member disengages from the groove of the insert member.

### CROSS-REFERENCE TO RELATED APPLICATIONS

This application is based on and claims priority under 35 U.S.C. § 119 to Korean Patent Application No. 10-2022-0157516, filed on Nov. 22, 2022, in the Korean Intellectual Property Office, the disclosure of which is incorporated by reference herein in its entirety.

### BACKGROUND OF THE INVENTION

### 1. Field

The disclosure relates to insert molding, in which an insert member is pre-installed in a mold for molding a product, such as a mold for injection molding of plastics or a mold for diecasting of light metal, and is then molded such that the insert member is integrally fixed to the molded product. More particularly, the disclosure relates to an apparatus for fixing an insert member in a mold, a mold apparatus, and an insert molding method, which are configured to securely fix the insert member to the mold while preventing an outer surface of the insert member from being exposed.

### 2. Description of the Related Art

In an insert molding method, an insert member is pre-installed in a mold for molding a product, and then a molten material is supplied to a cavity in the mold. The molten material solidifies in the cavity while being in contact with the insert member, thereby obtaining a molded product to which the insert member is integrally fixed.

For example, in order to mold a product, as illustrated in FIGS. 1 and 2, that includes an insert member 1 having an inner circumferential surface 1a and a plastic or metal material integrally covering outer surfaces (an outer circumferential surface and an upper surface) of the insert member 1, it may be considered to use a mold apparatus as illustrated in FIG. 2.

The mold apparatus illustrated in FIG. 2 includes a pair of molds 10 and 20 which are arranged in a molding machine so as to be in close contact with each other (mold closing) and spaced apart from each other (mold opening), and a coupling protrusion 10a is formed in one mold 10 among the pair of molds 10 and 20. The insert member 1 is inserted over the outer circumference of the coupling protrusion 10a. The inner circumferential surface 1a of the insert member 1 is brought into close contact with the outer circumferential surface of the coupling protrusion 10a, and lower and/or upper inner surfaces of the insert member 1 are brought into contact with the coupling protrusion 10a. Accordingly, the insert member 1 is prevented from moving in horizontal and downward directions. Also, push pins 21 are coupled to the other mold 20 among the pair of molds 10 and 20. When the pair of molds 10 and 20 are in a mold closed state (i.e., the mold 20 is brought into close contact with the mold 10 to form a cavity C as shown by a virtual line in FIG. 2), the push pins 21 press the upper surface of the insert member 1 and prevent the insert member 1 from moving upward.

When a molten material (a molten plastic or molten metal material) is injected into the cavity C during the mold closed state of the pair of molds 10 and 20, the molten material is solidified while being in contact with the outer surfaces (the outer circumferential surface and the upper surface) of the insert member 1 exposed to the cavity C, and thus, a product 7 having a shape corresponding to the cavity C is molded as shown in FIG. 3.

The product 7 molded as described above includes an insert member 1 integrally fixed to a solidified material 2. A reference numeral 1c in FIGS. 1 to 3 denotes an undercut portion that prevents the insert member 1 from separating from the solidified material 2.

However, since regions of the cavity C, where the push pins 21 were located, are not filled with a molten material, holes 2a corresponding to the shapes of the push pins 21 are formed in the molded product 7. Accordingly, the upper surface of the insert member 1 is exposed through the holes 2a. If the upper surface of the insert member 1 is exposed through the holes 2a, the following issues may occur.

For example, the product 7 may be coupled to another member 9 to constitute a gearbox case as schematically illustrated in FIG. 4. The inner circumferential surface 1a of the insert member 1 may be in contact with the outer circumferential surface of a bearing B that rotatably supports one end of a shaft (not shown) installed in the gearbox case. In this case, a lubricant contained in the bearing B may leak to the outside through the holes 2a, or external moisture may be introduced into the bearing B through the holes 2a. In order to avoid the occurrence of the above issues, it may be considered not to install the push pins 21 in the mold 20. However, if there are no push pins 21, the insert member 1 inserted over the coupling protrusion 10a is lifted in a direction opposite to the direction in which the insert member 1 is inserted over the coupling protrusion 10a (that is, lifted in a direction toward the mold 20) by the pressure of the molten material injected into the cavity C during the insert molding process. Accordingly, a new issue arises in which the insert member 1 deviates from the desired position.

### BRIEF SUMMARY OF THE INVENTION

Provided are an apparatus for fixing an insert member in a mold, a mold apparatus, and an insert molding method, which may securely fix the insert member having an inner circumferential surface to the mold and cover the entire outer surface of the insert member with a molded material.

Additional aspects will be set forth in part in the description which follows and, in part, will be apparent from the description, or may be learned by practice of the presented embodiments of the disclosure.

According to an aspect of the disclosure, an insert fixing apparatus, which is for fixing an insert member having an inner circumferential surface in a mold, includes a groove formed on the inner circumferential surface of the insert member, a coupling protrusion protruding from the mold so that the insert member is inserted over the coupling protrusion, the coupling protrusion having an outer circumferential surface in contact with the inner circumferential surface of the insert member, at least one hook member coupled to the mold such that a hook member moves between a protrusion position at which one end of the hook member protrudes from the outer circumferential surface of the coupling protrusion and a retreat position at which the one end of the hook member retreats from the outer circumferential surface of the coupling protrusion, wherein, when the hook member is located at the protrusion position, the one end of the hook member engages with the groove of the insert member to prevent the insert member from moving in a direction opposite to a direction in which the insert member is inserted over the coupling protrusion, and when the hook member is located at the retreat position, the one end of the hook member disengages from the groove of the insert member to allow the insert member to move in the direction opposite to the direction in which the insert member is inserted over the coupling protrusion, and a driving unit configured to move the at least one hook member between the protrusion position and the retreat position.

According to another aspect of the disclosure, a mold apparatus, which is for molding a product to which an insert member having a groove on an inner circumferential surface thereof is integrally fixed, includes a pair of molds configured to form a cavity in which the product is molded, a coupling protrusion protruding from one of the pair of molds so that the insert member is inserted over the coupling protrusion, the coupling protrusion having an outer circumferential surface in contact with the inner circumferential surface of the insert member, at least one hook member installed in the coupling protrusion such that a hook member moves between a protrusion position at which one end of the hook member protrudes from the outer circumferential surface of the coupling protrusion and engages with the groove of the insert member and a retreat position at which the one end of the hook member retreats from the outer circumferential surface of the coupling protrusion and disengages from the groove of the insert member, and a driving unit configured to move the at least one hook member between the protrusion position and the retreat position.

According to another aspect of the disclosure, an insert molding method, which uses the mold apparatus, includes inserting the insert member having the groove on the inner circumferential surface thereof over the coupling protrusion and bringing the inner circumferential surface of the insert member into contact with the outer circumferential surface of the coupling protrusion, moving the at least one hook member to the protrusion position after inserting the insert member over the coupling protrusion, so that the one end of the at least one hook member engages with the groove of the insert member to prevent the insert member from moving in the direction opposite to the direction in which the insert member is inserted over the coupling protrusion, and supplying a molten material into the cavity to mold the product to which the insert member is integrally fixed.

### BRIEF DESCRIPTION OF THE SEVERAL VIEWS OF THE DRAWING(S)

The above and other aspects, features, and advantages of certain embodiments of the disclosure will be more apparent from the following description taken in conjunction with the accompanying drawings, in which:

FIG. 1 is a schematic perspective view in which a portion of an example of an insert member is cut;

FIG. 2 is a schematic cross-sectional view of an example of a mold apparatus that may be used in a molding process in which the insert member of FIG. 1 is used;

FIG. 3 is a schematic cross-sectional view of a product molded by the mold apparatus of FIG. 2;

FIG. 4 is a view for illustrating an application example of the product of FIG. 3;

FIG. 5 is a schematic cross-sectional view of a mold apparatus according to an embodiment;

FIG. 6 is a view showing a state in which an insert member is inserted into the mold apparatus of FIG. 5;

FIG. 7 is an enlarged view of one end of a hook member illustrated on a right side of FIG. 6;

FIG. 8 is a schematic exploded perspective view of an insert fixing apparatus of FIG. 6;

FIG. 9 is a view showing a state in which the insert member of FIG. 6 is fixed by the insert fixing apparatus;

FIG. 10 is an enlarged view of one end of the hook member illustrated on a right side of FIG. 9;

FIG. 11 is a schematic cross-sectional view in which a pair of molds of FIG. 9 are in a mold closed state;

FIG. 12 is a schematic cross-sectional view of a product molded by the mold apparatus of FIG. 10;

FIG. 13 is a view showing the product of FIG. 12 in which a cutting process has been performed on the inner circumferential surface of the insert member to a certain thickness; and

FIG. 14 is a view for illustrating an application example of the product of FIG. 13.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments are described in detail with reference to the drawings. For reference, at least part of regions in each drawing may be shown with scales or dimensions appropriately exaggerated or reduced depending on the situation. Also, in each drawing, regions or parts that are not directly related to features of the disclosure may be briefly illustrated or omitted. In addition, orientations (up, down, left, right, etc.) in the description below are based on arrangement directions of a mold shown in the drawing, and thus, when the arrangement directions of the mold change, the orientations in the description below may also change. Also, in order to prevent the description of the disclosure from being unnecessarily lengthy, detailed descriptions of configurations or known techniques that are obvious to those skilled in the art are omitted.

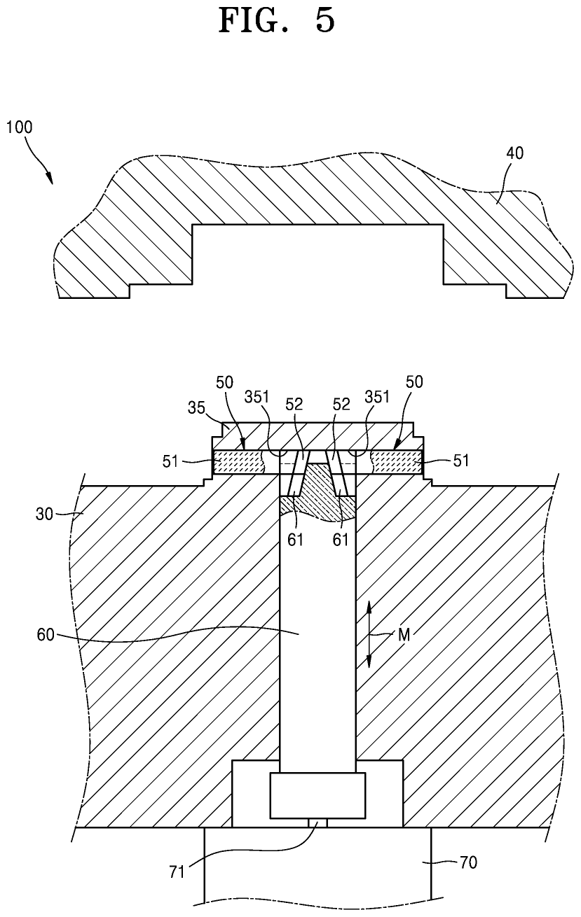

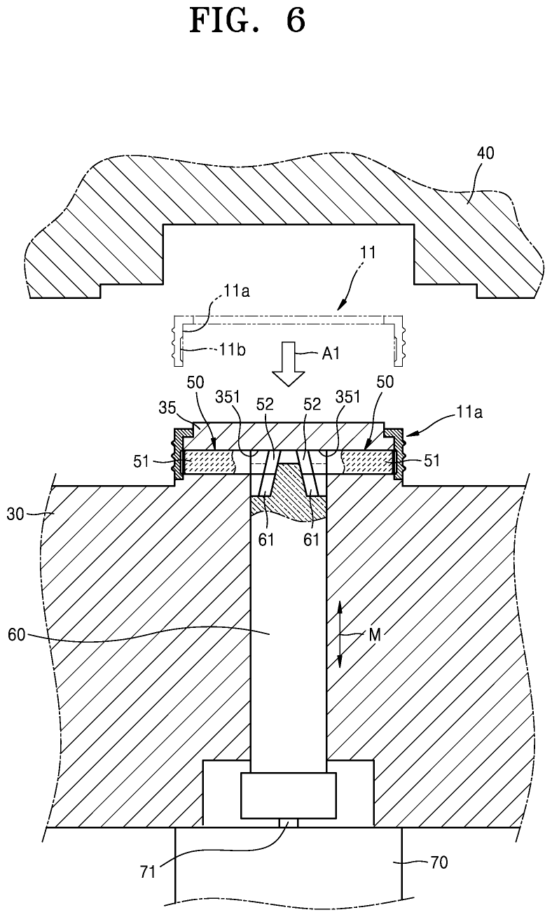

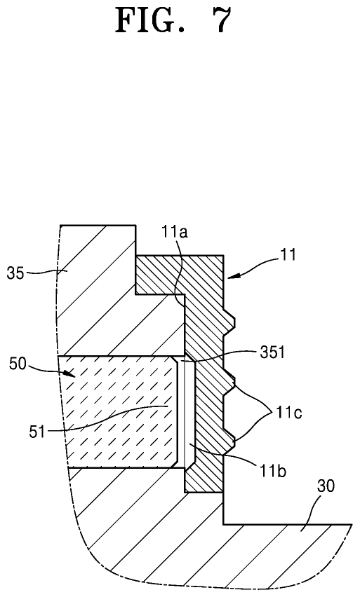

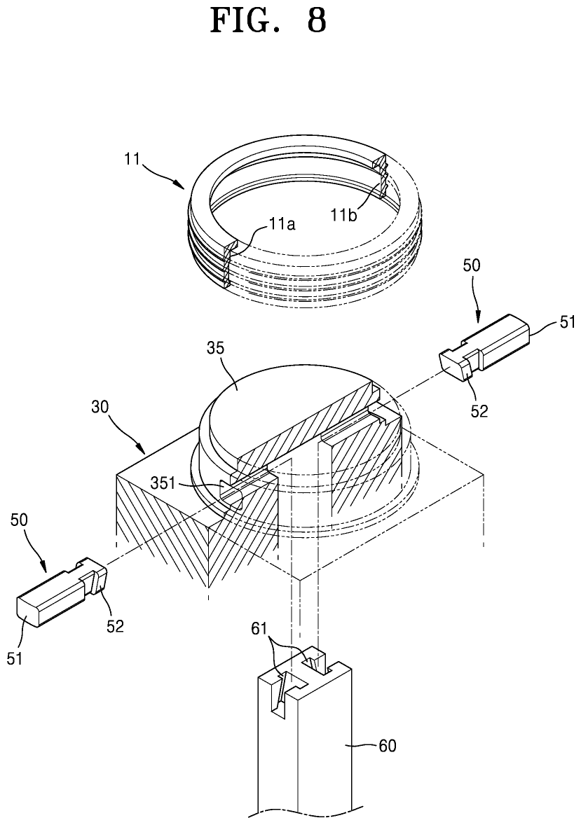

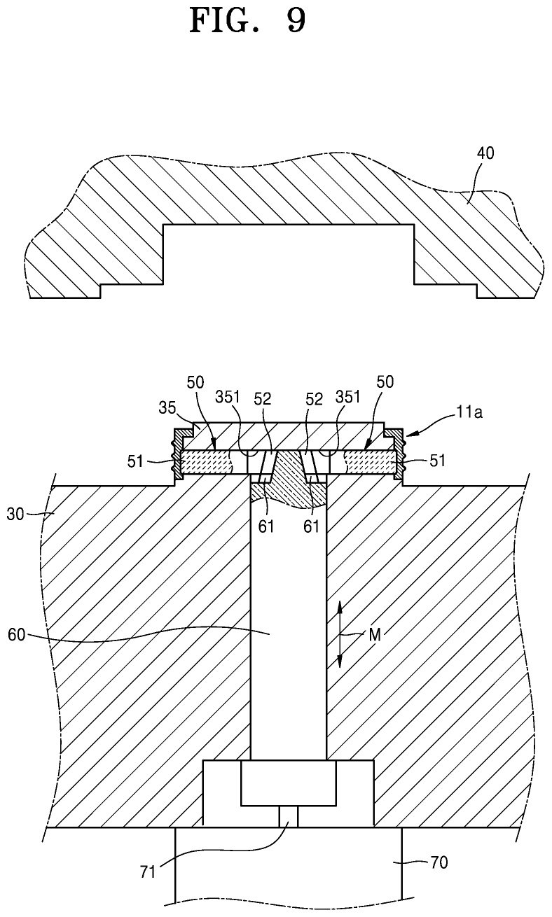

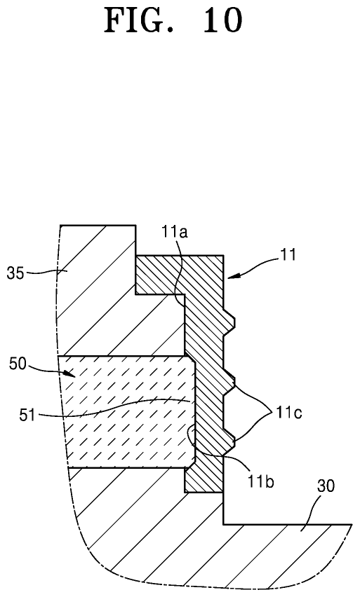

FIG. 5 is a schematic cross-sectional view of a mold apparatus 100 according to an embodiment, and FIG. 6 is a view showing a state in which an insert member 11 is inserted into the mold apparatus 100 of FIG. 5. FIG. 7 is an enlarged view of one end of a hook member 50 illustrated on a right side of FIG. 6, and FIG. 8 is a schematic exploded perspective view of an insert fixing apparatus of FIG. 6. FIG. 9 is a view showing a state in which the insert member 11 of FIG. 6 is fixed by the insert fixing apparatus, and FIG. 10 is an enlarged view of one end of the hook member 50 illustrated on a right side of FIG. 9.

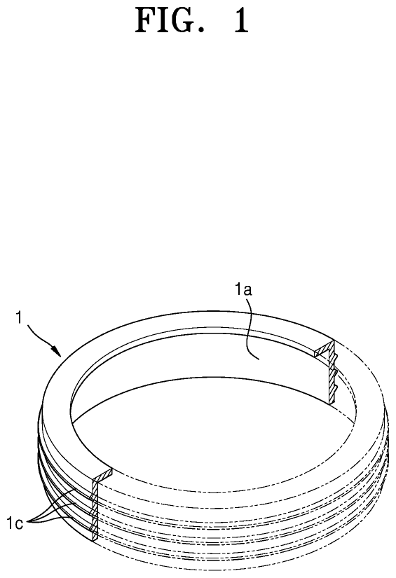

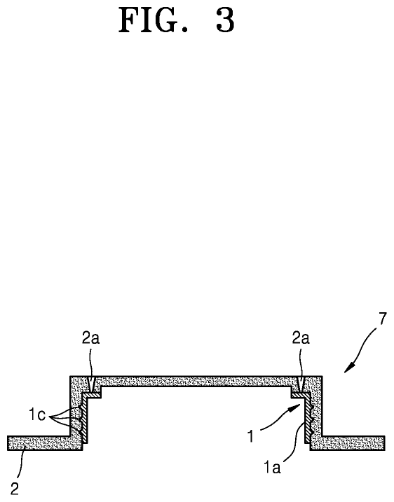

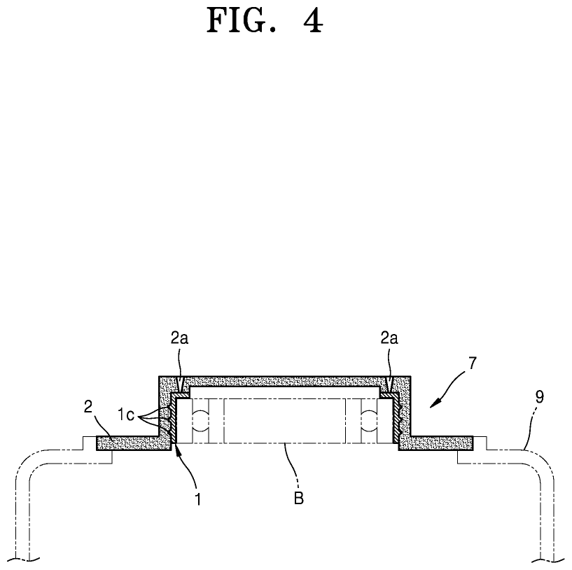

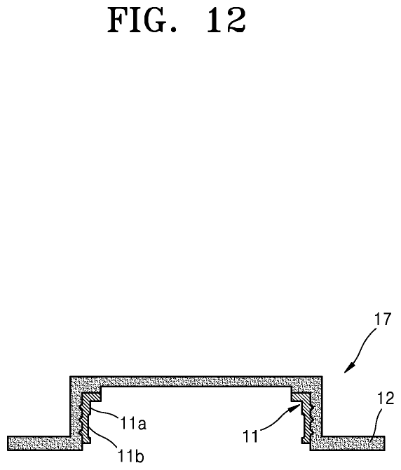

Referring to FIGS. 5 to 10, the mold apparatus 100 according to the embodiment is for molding a product 17 (see FIG. 12) to which the insert member 11 having a groove 11b on an inner circumferential surface 11a is integrally fixed. The groove 11b has an annular shape extending over the entire circumference of the inner circumferential surface 11a of the insert member 11. An undercut portion 11c protrudes on the outer circumferential surface of the insert member 11. The undercut portion 11c performs the same function as the undercut portion 1c described with reference to FIGS. 1 to 4.

The mold apparatus 100 includes a pair of molds 30 and 40, two hook members 50, and a driving unit.

The pair of molds 30 and 40 are mounted on a molding machine (not shown) so as to be in close contact with each other (mold closing) and spaced apart from each other (mold opening). When the molds 30 and 40 are in close contact with each other, a cavity C that is a molding space for a product is formed.

A coupling protrusion 35 protrudes from the mold 30 of the pair of molds 30 and 40. As shown in FIG. 6, the insert member 11 is inserted over the outer circumferential side of the coupling protrusion 35, and the inner circumferential surface 11a of the insert member 11 inserted over the coupling protrusion 35 is in contact with the outer circumferential surface of the coupling protrusion 35. Accordingly, it is possible to prevent movement of the insert member 11 in the horizontal direction, that is, movement of the insert member 11 in a direction perpendicular to an insertion direction A1 (FIG. 6) in which the insert member 11 is inserted over the coupling protrusion 35.

The two hook members 50 are arranged at intervals of 180 degrees around a cam member 60 described below. Since the two hook members 50 have the same structure, ‘each hook member’ and ‘two hook members’ may be referred to as a ‘hook member’ for simplicity of explanation in the following description. Each of the hook members 50 is installed in the mold 30 (specifically, in the coupling protrusion 35) so as to be movable between a protrusion position and a retreat position which are described below. Specifically, the hook member 50 is inserted into a guide hole 351 that is formed in the coupling protrusion 35 and extends linearly in the horizontal direction, and the hook member 50 may move between the protrusion position and the retreat position in the direction in which the guide hole 351 extends.

At the protrusion position of the hook member 50 as shown in FIGS. 9 and 10, one end 51 of the hook member 50 (an end located on the outer circumferential surface-side of the coupling protrusion 35) protrudes from the outer circumferential surface of the coupling protrusion 35 and engages with the groove 11b of the insert member 11. At the retreat position of the hook member 50 as shown in FIGS. 5 to 7, the one end 51 of the hook member 50 retreats from the outer circumferential surface of the coupling protrusion 35 and disengages from the groove 11b of the insert member 11.

The driving unit is for moving the hook members 50 between the protrusion position and the retreat position. In this embodiment, the driving unit includes the cam member 60, two cam followers 52, and a driving source.

The cam member 60 is installed in the mold 30 and may move in a first direction (a direction of arrow M in FIG. 5) perpendicular to the movement direction of the hook member 50 (the extension direction of the guide hole 351). Two inclined cam grooves 61 are provided at the upper end of the cam member 60 and respectively correspond to the two hook members 50. Since the two inclined cam grooves 61 have the same structure, ‘each inclined cam groove’ and ‘two inclined cam grooves’ may be referred to as an ‘inclined cam groove’ for simplicity of explanation in the following description.

The inclined cam groove 61 extends in a direction inclined relative to the first direction (the direction of arrow M1).

The two cam followers 52 are respectively provided at other ends of the two hook members 50 (an end opposite to the one end 51). The two cam followers 52 are respectively coupled to the inclined cam grooves 61 and move relative to the cam member 60 in the directions in which the inclined cam grooves 61 extend.

The driving source is provided to move the cam member 60 in the first direction perpendicular to the direction in which the hook member 50 moves. In the embodiment, a hydraulic cylinder 70 fixed to the mold 30 is provided as the driving source. A rod 71 (an output end) of the hydraulic cylinder 70 is connected to the cam member 60, and the cam member 60 is raised or lowered in the first direction as the rod 71 is moved vertically by the operation of the hydraulic cylinder 70.

The groove 11b formed on the inner circumferential surface 11a of the insert member 11, the coupling protrusion 35, the hook member 50, and the driving unit (the hydraulic cylinder 70) are included in the insert fixing apparatus for fixing the insert member 11 into the mold 30.

Hereinafter, an example of a process of molding the product 17 (see FIG. 12), to which the insert member 11 is integrally fixed, using the above-described mold apparatus 100 is described below.

First, as shown in FIG. 6, in a state in which the pair of molds 30 and 40 are opened (spaced apart from each other) and each of the hook members 50 is in the retreat position, the insert member 11 is inserted over the outer circumference of the coupling protrusion 35 in the direction of arrow A1 from above the coupling protrusion 35. During the process of inserting the insert member 11 over the coupling protrusion 35, the hook member 50 has retreated from the outer circumferential surface of the coupling protrusion 35. Therefore, the insert member 11 may be inserted over the coupling protrusion 35 without interference with the hook member 50. The insert member 11 inserted over the coupling protrusion 35 is prevented from moving in the horizontal direction because the inner circumferential surface 11a of the insert member 11 is in contact with the outer circumferential surface of the coupling protrusion 35.

After the insert member 11 is inserted over the coupling protrusion 35 as described above, the hydraulic cylinder 70 is operated by a controller (not shown). Accordingly, the rod 71 of the hydraulic cylinder 70 moves upward in the first direction as shown in FIG. 9. While the rod 71 moves upward as described above, the cam member 60 connected to the rod 71 also rises together. Accordingly, relative movement action between the inclined cam groove 61 and the cam follower 52 coupled to the inclined cam groove 61 (that is, a horizontal component of the force applied to the hook member 50 from the inclined cam groove 61 of the cam member 60) makes the hook member 50 move to the protrusion position as shown in FIGS. 9 and 10. As a result, the one end 51 of the hook member 50 engages with the groove 11b formed on the inner circumferential surface 11a of the insert member 11. Accordingly, the insert member 11 is prevented from moving in a direction away from the coupling protrusion 35 (a direction opposite to the insertion direction A1 of the insert member 11, that is, the upward direction).

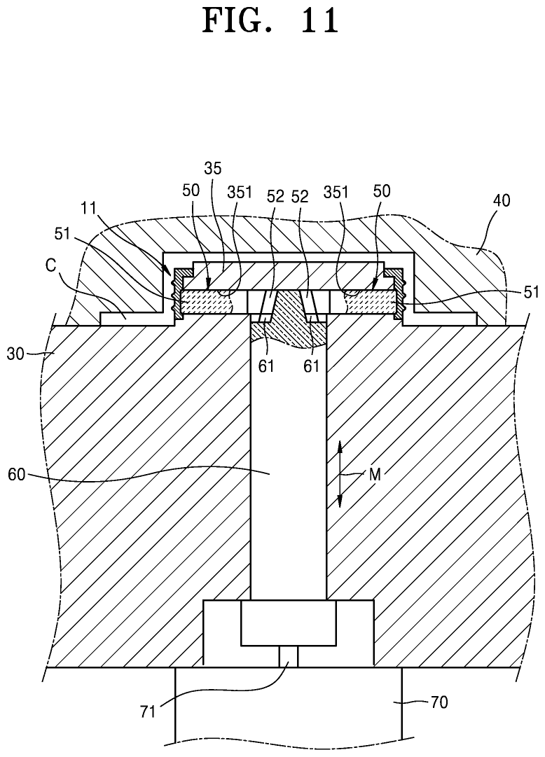

Then, as shown in FIG. 11, when the pair of molds 30 and 40 are brought into contact with each other, the cavity C is formed. Accordingly, the entire outer surfaces (the outer circumferential surface and the upper surface) of the insert member 11 are exposed to the cavity C. In this state, a melted material (a molten plastic or molten metal material, hereinafter referred to as the ‘molten material’) is injected into the cavity C and fills the cavity C while being in contact with the outer surface of the insert member 11. After a certain period of time has elapsed, the molten material injected into the cavity C is solidified and formed into the product 17 that has a shape corresponding to the cavity C as shown in FIG. 12.

When the molding of the product 17 is completed, the rod 71 of the hydraulic cylinder 70 is moved downward in the first direction by the operation of the hydraulic cylinder 70, and the cam member 60 connected to the rod 71 is lowered in the first direction. Accordingly, the relative movement action between the inclined cam groove 61 and the cam follower 52 relatively movably coupled to the inclined cam groove 61 (that is, the horizontal component of the force applied to the hook member 50 from the inclined cam groove 61 of the cam member 60) makes the hook member 50 move back to the retreat position as shown in FIGS. 6 and 7. As a result, the one end 51 of the hook member 50 and the groove 11b of the insert member 11 disengage from each other, and it becomes possible to extract the product 17, to which the insert member 11 is integrated, from the coupling protrusion 35. Also, before, after, or at the same time as the one end 51 of the hook member 50 as described above disengages from the groove 11b of the insert member 11, the pair of molds 30 and 40 are opened by the molding machine. As described above, in a state in which the pair of molds 30 and 40 are opened and the hook member 50 is positioned at the retreat position, the molded product 17 is extracted out from the mold apparatus 100.

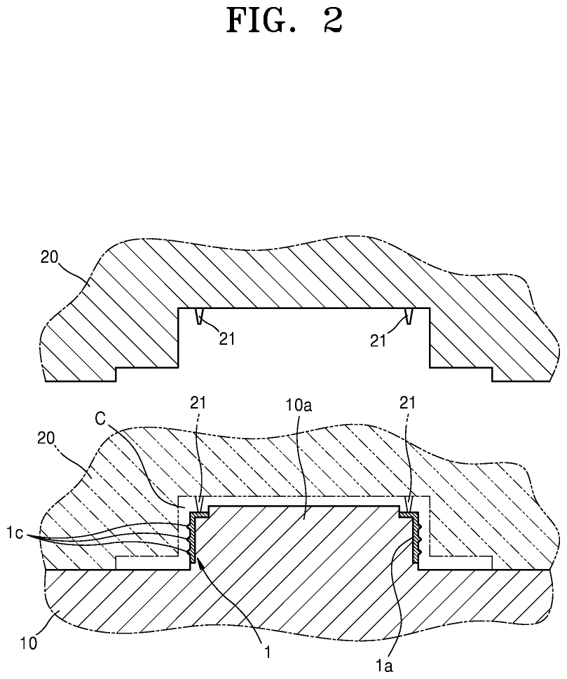

The product 17 includes the insert member 11 integrally fixed to a material 12 solidified (molded) in the cavity C as shown in FIG. 12, and the entire outer surfaces (the outer circumferential surface and the upper surface) of the insert member 11 are covered by the solidified (molded) material 12. That is, unlike the product 7 described with reference to FIGS. 2 to 4, a hole exposing the upper surface of the insert member 11 is not formed.

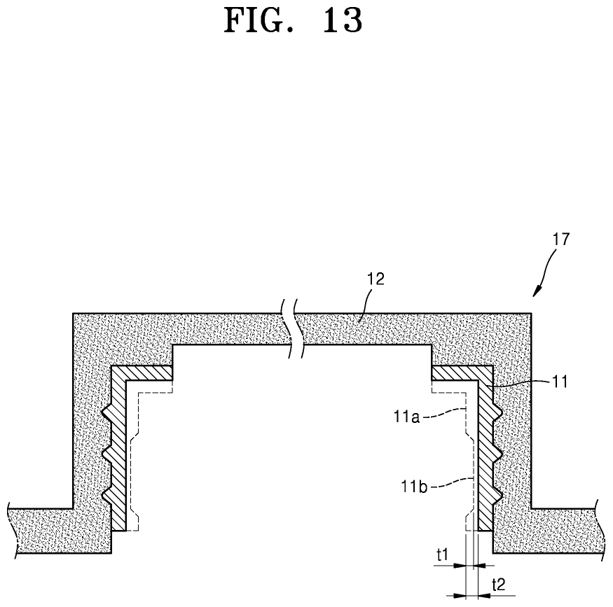

Also, if necessary, after the product 17 is molded, the groove 11b may be removed by cutting the inner circumferential surface 11a of the insert member 11 that has been integrated with the molded material 12. Specifically, the inner circumferential surface 11a of the insert member 11 in the product 17 shown in FIG. 12 is cut to a thickness t2 greater than a depth t1 of the groove 11b as shown in FIG. 13. Accordingly, it is possible to manufacture a product 17′ in which no grooves exist on the inner circumferential surface 11a of the insert member 11 that has been cut. That is, an insert member to be installed in a mold is manufactured to have an inner diameter smaller than a desired size of the insert member in a state of the product 17′ by an appropriate amount (a dimension larger than twice the depth of the groove). After forming the groove and molding the product 17, the groove is removed by cutting the inner circumferential surface of the insert member integrally included in the product 17 by the appropriate amount described above. Accordingly, it is possible to manufacture the product 17′ in which the inner diameter of the insert member finally has the desired size. A region shown by a virtual line in FIG. 13 represents the shape of the inner surface of the insert member before cutting is performed (that is, the shape of the inner surface of the insert member 11 in the product 17 in FIG. 12). In addition, when cutting the inner circumferential surface of the insert member 11 as described above, the upper inner surface of the insert member 11 may also be cut by a certain amount, if necessary, as shown in FIG. 13.

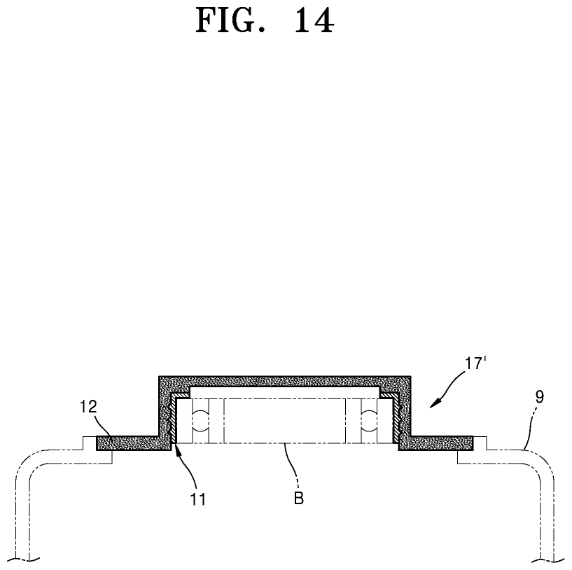

As described above, the product 17′, from which the groove on the inner circumferential surface of the insert member 11 is removed by a cutting process after the insert molding, is coupled to another member 9 to constitute a gearbox case as shown, for example, in FIG. 14. Also, the insert member 11 may function as a bearing case that accommodates and supports a bearing B for rotatably supporting one end of a shaft accommodated in the gearbox case (not shown, for example, a shaft on which a driving gear is fixed, a shaft on which a driven gear is fixed, a shaft on which a connection gear for connecting the driving gear and the driven gear is fixed, or the like). That is, the bearing B may be accommodated and supported inside the insert member 11 (the bearing case) of the product 17′ in a state in which the outer circumferential surface (an outer ring) of the bearing B is in contact with the inner circumferential surface of the insert member 11. As described above, when the product 17′ constitutes part of the gearbox case and accommodates and supports the bearing B, the outer surfaces (the outer circumferential surface and the upper surface) of the insert member 11 (the bearing case) are completely covered by the molded material 12 and are thus not exposed to the outside. Accordingly, unlike the product 7 described with reference to FIGS. 2 to 4, it is possible to reliably prevent a lubricant contained in the bearing B from leaking to the outside or external moisture from being introduced into the bearing B.

Also, when the product 17′ is used as a product constituting part of the gearbox case as described above, the molded material 12 may include aluminum and the insert member 11 may include steel. That is, the insert member (the bearing case) including the steel may be integrally fixed to the molded material that is formed by aluminum die casting. In this case, even if vibration due to rotation of a shaft or vibration input from the outside is transmitted to the bearing case (the insert member 11) or the gearbox case, the bearing case may be securely positioned relative to the gearbox case. In addition, even if the bearing B vibrates relative to the bearing case (the insert member 11), the bearing case may be effectively prevented from being worn or deformed because the bearing case includes the steel having greater strength than the aluminum of the molded material 12.

Also, in the above-described embodiment, although the groove 11b formed on the inner circumferential surface 11a of the insert member 11 is described and illustrated as an annular groove that extends over the entire inner circumferential surface 11a of the insert member 11, the groove 11b formed on the inner circumferential surface 11a of the insert member 11 is not limited to the annular groove. For example, two grooves spaced apart from each other may be respectively formed at two positions corresponding to ends 51 of the two hook members 50 and respectively engage with the ends 51 of the hook members 50.

Although the above embodiment is described and illustrated as including two hook members 50, one hook member or three or more hook members may be provided in some embodiments. In this case, inclined cam grooves and cam followers may be provided in the same number as the hook members.

In addition, the uses, functions, structures, shapes, and the like of the insert member 11 and the molded products 17 and 17′ to which the insert member 11 is integrated are not limited to those described above and illustrated in the drawings, and various changes may be made without departing from the technical ideas of the disclosure.

According to the embodiment, it is possible to obtain the molded product that includes the insert member of which the inner circumferential surface is exposed and of which the entire outer surfaces are covered by the molded material.

The above effects and other effects can be easily understood from the description of embodiments.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An insert fixing apparatus for fixing an insert member having an inner circumferential surface in a mold, the insert fixing apparatus comprising:
a groove formed on the inner circumferential surface of the insert member;
a coupling protrusion protruding from the mold so that the insert member is inserted over the coupling protrusion, the coupling protrusion having an outer circumferential surface in contact with the inner circumferential surface of the insert member;
at least one hook member coupled to the mold such that a hook member moves between a protrusion position at which one end of the hook member protrudes from the outer circumferential surface of the coupling protrusion and a retreat position at which the one end of the hook member retreats from the outer circumferential surface of the coupling protrusion, wherein, when the hook member is located at the protrusion position, the one end of the hook member engages with the groove of the insert member to prevent the insert member from moving in a direction opposite to a direction in which the insert member is inserted over the coupling protrusion, and when the hook member is located at the retreat position, the one end of the hook member disengages from the groove of the insert member to allow the insert member to move in the direction opposite to the direction in which the insert member is inserted over the coupling protrusion; and
a driving unit configured to move the at least one hook member between the protrusion position and the retreat position.

2. The insert fixing apparatus of claim 1, wherein the driving unit comprises:
a cam member installed to be movable in a first direction perpendicular to a direction in which the at least one hook member moves, the cam member having at least one inclined cam groove that extends in a direction inclined relative to the first direction;
at least one cam follower provided at another end of the at least one hook member, the at least one cam follower being coupled to the at least one inclined cam groove such that the at least one cam follower moves relative to the cam member in the direction in which the at least one inclined cam groove extends; and
a driving source connected to the cam member to move the cam member in the first direction.

3. A mold apparatus for molding a product to which an insert member having a groove on an inner circumferential surface thereof is integrally fixed, the mold apparatus comprising:
a pair of molds configured to form a cavity in which the product is molded;
a coupling protrusion protruding from one of the pair of molds so that the insert member is inserted over the coupling protrusion, the coupling protrusion having an outer circumferential surface in contact with the inner circumferential surface of the insert member;
at least one hook member installed in the coupling protrusion such that a hook member moves between a protrusion position at which one end of the hook member protrudes from the outer circumferential surface of the coupling protrusion and engages with the groove of the insert member and a retreat position at which the one end of the hook member retreats from the outer circumferential surface of the coupling protrusion and disengages from the groove of the insert member; and
a driving unit configured to move the at least one hook member between the protrusion position and the retreat position.

4. The mold apparatus of claim 3, wherein the driving unit comprises:
a cam member installed to be movable in a first direction perpendicular to a direction in which the at least one hook member moves, the cam member having at least one inclined cam groove that extends in a direction inclined relative to the first direction;
at least one cam follower provided at another end of the at least one hook member, the at least one cam follower being coupled to the at least one inclined cam groove such that the at least one cam follower moves relative to the cam member in the direction in which the at least one inclined cam groove extends; and
a driving source connected to the cam member to move the cam member in the first direction.

5. An insert molding method using the mold apparatus of claim 3, the insert molding method comprising:
inserting the insert member having the groove on the inner circumferential surface thereof over the coupling protrusion and bringing the inner circumferential surface of the insert member into contact with the outer circumferential surface of the coupling protrusion;
moving the at least one hook member to the protrusion position after inserting the insert member over the coupling protrusion, so that the one end of the at least one hook member engages with the groove of the insert member to prevent the insert member from moving in the direction opposite to the direction in which the insert member is inserted over the coupling protrusion; and
supplying a molten material into the cavity to mold the product to which the insert member is integrally fixed.

6. The insert molding method of claim 5, further comprising removing the groove by cutting the inner circumferential surface of the insert member that is integrally fixed to the molded product.
